(19) United States
(12) Patent Application Publication
(10) Pub. No.: US 2004/0210348 A1
(43) Pub. Date: Oct. 21, 2004

(54) Building system with network operation monitoring

(76) Inventors: Raphael Imhof, Arlington Heights, IL (US); Thomas Anderson, Lakemoor, IL (US)

Correspondence Address: Michael J. Wallace, Intellectual Property Counsel, Siemens Corporation, 170 Wood Avenue South, 5th Floor, Iselin, NJ, 08830, US

(21) Appl. No.: 10/818,461

(22) Filed: Apr. 5, 2004

Related U.S. Application Data
(60) Provisional application No. 60/460,276, filed on Apr. 4, 2003.

(51) Int. Cl. G05B 13/00

(52) U.S. Cl. 700/275; 700/276

(57) ABSTRACT

An arrangement for use in a building system includes a building control station that is operably connected to a first network. The building control station has a first network address on the first network. The building control station further includes a building control object, a network monitor, and a network interface. The building control object is operable to process building control data. The network monitor is operable to determine at least a first statistic regard the first network. The network interface is operable to receive first and second messages on the first network, and to provide first messages to the building control object and the network monitor. The network interface is further operable to provide second messages only to the network monitor.

This application claims the benefit of U.S. Provisional Patent Application Serial No. 60/460,276, filed Apr. 4, 2003, which is incorporated herein by reference.

### FIELD OF THE INVENTION

The present invention relates generally to building control systems, such of the type that control heating, ventilation, air conditioning, fire safety, lighting, security and other systems of a building or facility.

### BACKGROUND OF THE INVENTION

Building control systems are employed to regulate and control various environmental and safety aspects of commercial, industrial and residential facilities (hereinafter referred to as “buildings”). In ordinary single-family residences, control systems tend to be simple and largely unintegrated. However, in large buildings, building control systems often consist of multiple, integrated subsystems employing hundreds of elements.

For example, a heating, ventilation and air-conditioning (“HVAC”) building control system combines small, local control loops with larger control loops to coordinate the delivery of heat, vented air, and chilled air to various locations throughout a large building. Local control loops, for example, open and close vents that supply heated or chilled air based on local room temperature readings. Larger control loops, for example, obtain many distributed temperature readings and/or air flow readings to control the speed of a ventilation fan, or control the operation of heating or chilling equipment. Other building control systems such as fire safety and security systems employ a similar model.

As a consequence of the interrelationship of these control loops, many elements of a building control system must communicate information to each other. To this end, communication networks have been incorporated that transmit digital data between and among the various elements. Many systems employ multiple networks at multiple levels, which allows for increased flexibility and scalability of the building control system. To this end, a building control system may include both closed, system specific communication networks and higher level networks for building-wide and even enterprise-wide communications. Closed networks, (e.g. token bus networks) tend to be more bandwidth efficient and require less infrastructure while open networks (e.g. Ethernet local area networks) tend to require more bandwidth. Building control systems often employ both types of networks (as well as others) to obtain the benefits of each network type where desired.

For example, the Apogee™ System available from Siemens Building Technologies, Inc. of Buffalo Grove, Ill. uses multiple network levels, including a management level Ethernet and a building level token bus network.

Because of the extensive reliance on complex communication networks in building systems, it is essential that the communication networks in these systems are operating properly. Indeed, the operation of the communication network can be as important to proper building control system function as the operation of the actual control system devices.

To this end, building owners/managers desire to have the capability to review the bandwidth usage and/or message rates, particularly on deterministic networks such as proprietary token bus networks. Such information is useful in diagnosing problems in the building control system, particular those that may arise with respect to the communication system.

Some standalone monitoring tools have been developed that connect directly to the network being monitored. These tools, such as the standalone Sniffer™ product available from Siemens Building Technologies, Inc. provide sufficient network monitoring, but create additional hardware costs.

There is a need, therefore, for a more cost efficient method and apparatus for obtaining network usage information in a building control system network.

### SUMMARY OF THE INVENTION

The present addresses the above needs, as well as others, by providing a building control system computing device that operates both as a building system control station and also operates as a building system network monitor. As a building system control station, the computing device allows for monitoring of and/or control of various remote building control devices. As a building system network monitor, the computing device enables monitoring and diagnostics relating to the communication system employed by the building system devices.

A first embodiment of the invention is an arrangement for use in a building system that includes a building control station operably connected to a first network. The building control station has a first network address on the first network. The building control station further includes a building control object, a network monitor, and a network interface. The building control object is operable to process building control data. The network monitor is operable to determine at least a first statistic regard the first network. The network interface is operable to receive first and second messages on the first network, and to provide first messages to the building control object and the network monitor. The network interface is further operable to provide second messages only to the network monitor.

Thus, the building control station according to this embodiment receives all messages, but only performs building control operations on message addressed to the building control station. The building control station updates monitoring statistics using all of the messages to obtain network operational information.

A second embodiment of the invention is a method that includes receiving at a first computing device a first message from a first network, the first message including a first destination address and building control data pertaining to the operation of one of a plurality of building control devices. The method also includes updating a first network usage statistic maintained in the first computing device responsive to receiving a first message. The method further includes processing the building control data in the first computing device responsive to receiving the first message if the first destination address corresponds to the first computing device.

Another embodiment of the invention provides a method for obtaining network usage information and communicating the information over the Internet. The method includes receiving at a first computing device a first message from a first network, the first message including a first -destination address and building control data pertaining to the operation of one of a plurality of building control devices, at least some of the building control devices operably connected to the first network. The method also includes updating a first network usage statistic maintained in the first computing device responsive to receiving the first message. The method further includes communicating information representative of the first network usage statistic to one of the plurality of other computing devices using the Internet.

It is noted that certain advantages may be obtained by employing any novel combination of features described herein. Moreover, while a particular embodiment is described herein, other embodiments not described but which incorporate the inventive features will benefit from one or more of the advantages of one or more inventive aspects disclosed herein.

The above described features and advantages, as well as others, will become more readily apparent to those of ordinary skill in the art by reference to the following detailed description and accompanying drawings.

### BRIEF DESCRIPTION OF THE DRAWINGS

FIG. 1 shows a block diagram of an exemplary building control system in accordance with the present invention;

FIG. 2 shows a block diagram of an exemplary control station of the building control system of FIG. 1;

FIG. 3 shows a flow diagram of an exemplary set of operations of the network communication driver of the control station of FIG. 2;

FIG. 4 shows a flow diagram of an exemplary message extractor of the control station of FIG. 2; and

FIG. 5 shows a logical block diagram of the network diagnostic application executed by the control station of FIG. 2;

FIG. 6 shows a block diagram of an arrangement for obtaining network usage data and communicating the data to a remote computer in accordance with aspects of the invention; and

FIG. 7 shows a block diagram of an alternative embodiment of the control station of FIG. 2.

### DETAILED DESCRIPTION

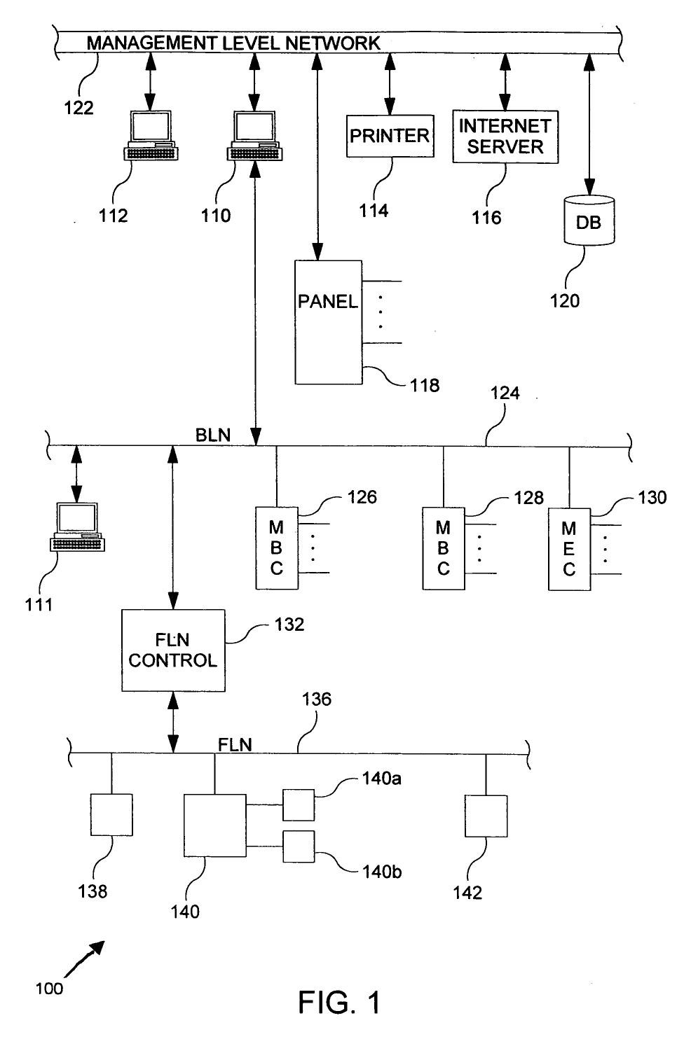

FIG. 1 shows a block diagram of an exemplary building control system 100. The exemplary embodiment of the building control system 100 in FIG. 1 has the general architecture of commercially available building control systems, including but not limited to the APOGEE® System available from Siemens Building Technologies, Inc. of Buffalo Grove, Ill. In accordance with the present invention, the building control system 100 of FIG. 1 further includes a control station 1 10 that is operable to provide both control over the building control devices of the system 100 and further provide communication network performance data as will be described further below. Those of ordinary skill in the art will readily appreciate that the use of the inventive control station I 10 and/or methods described herein are in no way limited to the system 100 of FIG. 1, but instead may readily be incorporated into any building system that includes distributed devices and a control station that communicates directly or indirectly with such devices via a network.

The building system 100 of FIG. 1 includes three levels of networks to accommodate modularity and scalability. Low level or floor level networks (e.g. network 136) are typically small deterministic networks with limited flexibility or bandwidth, but which provide for control data communication between locally controlled devices. Building level networks (e.g. building level network 124) are medium level networks that are the backbone of the building control system 100. A building level network typically connects to several floor level network and possibly large equipment, and further is connected to the control stations that allow for monitoring of all system data. Building level networks must have significant bandwidth, but do not require open access. As a result, the building level network 124 in the embodiment described herein is a token bus network. The management level network 122 is a high level network used for interfacing with internal and external workstations, data repositories, and printing devices. The management level network 122 in the exemplary embodiment described herein is an open protocol network (e.g. Ethernet) that enables remote access to data within the system 100.

In the exemplary embodiment described herein, various data communication performance parameters of the building level network 124 are monitored. The building level network 124 is responsible for relaying data throughout the building control elements (i.e. ventilation damper controllers, chiller plant controllers, temperature sensors, alarm systems)

Referring now specifically to FIG. 1, the building control system 100 includes a first control station 110, a second control station 112, a printer 114, an internet server 116, a control panel 118, and a database 120 all operably interconnected via the management level network 122. The management level network 122 may suitably be an Ethernet standard network that employs the TCP/IP protocol. The control station 110 is further connected to the building network 124, which in the embodiment described herein is a token bus network.

The printer 114 and internet server 116 are standard components as is known in the art. The control panel 118 is an Ethernet-ready control panel that may be used to connect to another network of building control devices, not shown. The database 120 may suitably be a database server and includes memory for storing data regarding the structure of the system 100, as well as archived data regarding the operation of the system 100.

The control station 110 is a device that includes a user interface and is operable to provide user control over (and/or monitoring of) the building control elements/devices of the system 100 in a-manner which may suitably be the same as that provided by the model INSIGHT® Work Station used in connection with the APOGEE®, discussed above. The INSIGHT® Work Station is also available from Siemens Building Technologies, Inc, of Buffalo Grove, Ill. To provide such control, the control station 110 communicates building control data to and from such devices (directly or indirectly) over the building network 124.

As discussed above, data communication performance parameters of the building control network 124 are monitored. To this end, the control station 110 of the embodiment of the invention described herein is further operable to generate network usage information for the building control network 124. Operators and/or other software may employ the usage information to gauge and monitor the efficiency and quality of network operations within the building control network 124.

Preferably, the control station 110 is operable to generate various usage statistics and other performance data from the network usage information. The control station 110 is operable to display such information and/or statistics, or generally, network performance data, responsive to user requests, and/or communicate such network performance data to devices connected to the management level network 122. For example, the network performance data may be communicated via the management level network 122 to remote access points via the Internet server 116.

The building control system 100 further includes various building control devices, such as modular building controllers 126, 128, modular equipment controllers 130, and floor level network controllers 132, which are operably connected to the building network 124. The building control devices either directly or indirectly control, detect, and/or measure environmental parameters of the building. Such parameters include temperature, air quality, smoke detection, fire detection, and other parameters normally controlled, detected and/or measured by HVAC systems, building security systems and/or building fire safety systems. Such devices are known in the art. By way of example, the modular equipment controller 130 may control a chiller plant of a building, not shown.

The floor level controller 132 is further connected a floor level network 136. The floor level network 136 is a low level network that may employ either an open communication protocol or a proprietary protocol, and which connects to further building control devices. Exemplary building control devices of the system 100 which are connected to the floor level network 136 include unitary controllers 138, terminal equipment controllers 140, and variable speed drives 142. Other HVAC, fire safety, security, and building (or factory) automation devices are well known in the art and may be connected to the floor level network 136 or the building level network 124.

It is noted that the modular building controllers 126 and 128 may connect to other floor level networks, not shown, which include other building control devices, not shown. Thus, the system 100 is expandable and modular.

In any event, the various building control devices generate building control information from time to time. For example, the terminal equipment controller 140 may be used to regulate temperature in a particular physical space or room. To this end, the terminal equipment controller 140 may be connected to a temperature sensor 140a. In such an example, the terminal equipment controller 140 obtains and/or may access building control information in the form of the temperature sensor readings from the sensor 140a. In another example, a motion sensor of a building security system, not shown, may generate a signal indicative of detected motion.

Also from time to time, an operator may use the control station 110 to request a subset of the available building control information generated by the building control devices. The control station obtains such information via the interlinked networks and devices as is known in the art.

In addition, an operator may also use the control station 110 to provide a “command” to one or more of the building control devices. Such commands are provided to the various building devices through the same networks and devices. For example, a command may be used to set a desire temperature, or temperature set point, for a room, space or entire building.

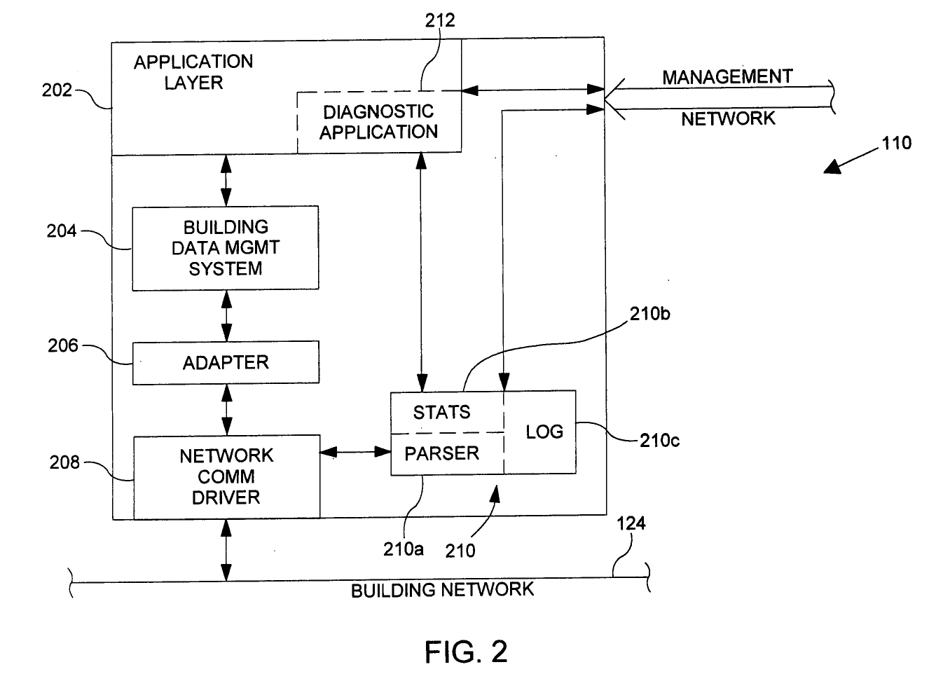

Referring to FIG. 2, the control station 110 may suitably be a general purpose computer which can include one or more expansion cards or modules to carry out particular communication operations, for example, Ethernet communications or other protocols, on the management level network 122. FIG. 2 shows a functional block diagram of the control station 110. The functional blocks shown in FIG. 2 are carried out by a suitably configured combination of hardware and software within the control station.

Referring specifically to FIG. 2, the control station 110 includes an application layer 202, a building data management system (client/server combined in this case) 204, an adapter 206, and a network communication driver 208. The control station 110 further includes a message extractor 210.

The application layer 202 provides all user interface functions as well as special control applications. The building data management system 204 includes, among other things, the data server that controls, among other things, 1) the obtaining of data from remote system devices via the building level network 124 pursuant to requests made by the application layer 202, 2) the communication of commands from the application layer 202 to remote system devices via the building level network 124, and 3) the obtaining of alarm information from the remote system devices via the building level network 124. The building data management system 204 is preferably operably connected to obtain other data from, and communicate data to, the database 120. By way of example, an application on the application layer 202 may request certain data from the building data management system 204 from time to time, perform operations on the data, and then store the data on the database 120 using the management level network 122. Such operations are known in the building control system art.

The adapter 206 is a device driver system that converts or maps data between the format employed by the application layer 202/building data management system 204 and the format employed by the various building control devices. As is known in the art, various building system devices employ various formats of data and/or units of data. The adapter 206 operates to convert between the various formats and a common data format used by the building data management system 204.

The network communication driver 208 is the device that adds the protocol layers necessary for communication over the building network 124.

Examples of all of the above described devices would be known in the art and may be found, for example, in the INSIGHT™ Work Station available from Siemens Building Technologies, Inc.

Referring to FIGS. 1 and 2, two exemplary operations of the building system 100 are described below. The first operation involves satisfying a request for a data value for a particular network point or device. The second operation involves adjusting a set point or data value in the facility.

Data Value Reporting

Many operations of the building system 100 involve the reporting of data from individual building system devices or points. To illustrate such operations, an example is described below in which a temperature value is reported for a particular room. It will be assumed for the purpose of the example that the temperature value is reported responsive to a request generated within the application layer 202. In particular, assume that the application layer 202 requests a temperature value as measured by the temperature sensor 140a.

It is noted that several applications within the application layer 202 may be able to generate such a request. For example, the application layer 202 preferably has an application that allows a user to enter a request via a graphical user interface (or text interface) directly on the control station 110. Alternatively, the application layer 202 has another application that allows for requests for data to be received from an external device via the management level network 122. Such applications may take many forms. Instead of a request for the particular device, the request may be formulated as a request for a temperature reading in the room in which the temperature sensor 140a is located.

The application layer 202 passes the request to the building data management system 204. The building data management system 204 receives the request and associates the request with a particular point or value available in the system, i.e. the temperature value measured-by the temperature sensor 140a. The building data management system 204 further determines that the temperature data from the temperature sensor 140a is available from the terminal equipment controller 140 through the floor network controller 132. Accordingly, the building data management system 204 generates a request for the temperature data from the terminal equipment controller 140 via the floor network controller 132. The building data management system 204 provides the request to the adapter 206.

The adapter 206 then translates the request for data into the format expected by the particular make and model of the floor level controller 132. The adapter 206 then provides the request to the network communication driver 208.

The network communication driver 208 generates a network message for the building control network 124 that is addressed to the floor level controller 132. The network message includes the translated data request received from the adapter 206 and further includes the building level protocol/overhead layers added by the driver 208. The network communication driver 208 then sends the message out on the network 124.

While the message may propagate to many devices (e.g. devices 126, 128, 130 and 132) on the management level network 124, only the floor network controller 132 receives (i.e. processes) the message. The floor level network controller 132 then obtains the temperature data from the terminal equipment controller 140. To this end, the floor level network controller 132 typically stores recent temperature data received from the terminal equipment controller 140 over the floor level network 136. In some cases, the floor level network controller 132 obtains such data in the normal course of operations, and thus, may respond to the request with information it already possesses. In other cases, the floor level network control 132 may generate a request for such information from the terminal equipment controller 140 that is communicated over the floor level network 136.

In such a case, the terminal equipment controller 140 sends a message that includes data representative of its current temperature measurement of the temperature sensor 140a over the floor network 136 to the floor level network controller 132. The floor level network controller 132 receives the message and provides the measurement data in a message format compatible for transmission over the building level network 124. The control station 110 receives the message from the building level network 124. More specifically, the network communication driver 208 receives the message from the building level network 124, and parses the temperature measurement data therefrom. As discussed above, the measurement data is in a data format used by the temperature sensor 140a and/or the floor network controller 132. The adapter 206 determines the appropriate driver and converts the data into the common data format used by the building data management system 204. Thus, while the different building control devices may use a broad array of data formats, command formats, or measurement units, the adapter 206 contains the various drivers to convert the broad array of formats into a single common format.

In any event, the building data management system 204 obtains the converted data from the adapter 206 and makes the data available to the application of the application layer 202 that requested the data. The application layer 202 may then cause the data to be displayed locally, or communicated to another device via the management level network 122. If the data is provided to the Internet server 116, the Internet server 116 may generate an HTML page or XML page as is known in the art to communicate the temperature data to a remote computer over the Internet.

System Command

Another exemplary operation involves the communication of a “command” message from the control station 110 to a building system device. In this example, an operator uses an application from the application layer 202 to generate a command, such as, for example, to set the temperature set point in a space or room of the building.

A temperature set point, as is known in the art, is a desired temperature that a building control system attempts to maintain within a certain space. For example, the temperature setting on a home thermostat is a “temperature set point”. In the exemplary embodiment described herein, the terminal equipment controller 140 is configured to control the temperature in the space in which the sensor 140a is located. To this end, the terminal equipment controller is connected to a ventilation damper actuator 140b. The terminal equipment controller 140 may manipulate the temperature in the room by controlling the actuator 140b to open or close a ventilation duct damper, not shown. The terminal equipment controller 140 attempts to maintain the temperature at the sensor 140a approximately equal to the temperature set point by opening or closing the ventilation damper as needed. Such operations are known in the art.

Accordingly, one common example of a system command is one in which a temperature set point is communicated to a device such as the terminal equipment controller 140. The temperature controller 140 would then operate the actuator 140b to attempt to achieve and maintain the set point temperature. Such an example is described herebelow.

The building data management system 204 receives the command or request from the application layer 202, and determines where to send the command. For example, in response to In particular, the building control system data server 204 determines that commands for the terminal equipment controller 140 should be sent through the floor level network controller 132. The building data management system 204 provides the command and the destination information to the adapter 206. The adapter 206 employs the driver appropriate for the destination device (i.e. the terminal equipment controller 140) to convert the command to one that is in a format used by the device. The adapter 206 provides the converted command to the network communication driver 208. The network communication driver 208 adds the building level protocol/overhead layers and transmits the message to the floor level controller 132 via the building level network 204. The floor level controller 132 obtains the command data from the message and then communicates the command data to the terminal equipment controller 140 using the floor level network 136. The terminal equipment controller 140 would thereafter manipulate the actuator 140b to attempt to maintain the room temperature at the newly received set point.

Network Monitoring

In addition to the above described operations, which are common in control stations of building automation systems, the control station 110 also performs network usage monitoring and/or network statistic calculation in accordance with the present invention.

To perform network usage monitoring in accordance with the present invention, the message extractor 210 is preferably operable to obtain substantially every message from the building level network 124 via the network communication driver 208, regardless of whether the message is addressed to the building data management system 204.

In particular, some messages on the building level network 124 do not originate or terminate at the control station 110, but rather constitute communications between other devices or nodes on the building network 124. For example, modular building controllers 126 and 128 may communicate various control communication to each other over the building network 124. In another example, another control station 111 may be connected to the network 124. In any event, these messages are not processed by the adapter 206 or building data management system 204 because they are not addressed to the building data management system 204. To this end, the network communication driver 208 determines which messages are intended for the building data management system 204 and passes these messages to the building data management system 204 (i.e. through the adapter 206 in this embodiment). All messages addressed to other nodes are not passed on to the building data management system 204. However, in accordance with the present invention, the network communication driver 208 passes all messages, including those addressed to other nodes, onto the message extractor 210 for the purpose of monitoring network usage.

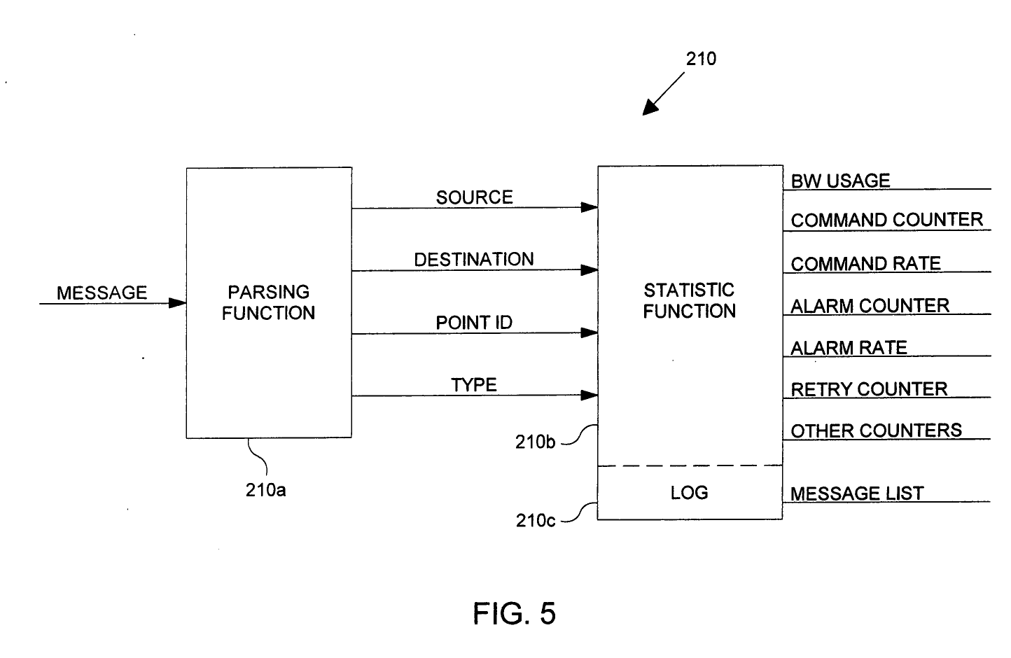

The message extractor 210 is preferably a software object running on the control station 110 that obtains traffic-related data from each message. To this end, the message extractor 210 preferably includes a parser function 210a and a statistics function 210b. (See also FIG. 5). For each message transmitted on the building network 124, the parser function 210a of the message extractor 210 parses destination, source, type and other information and provides the information to the statistics function 210b. The statistics function 210b then uses the information to generate various statistics.

The message extractor 210 may be accessed by a network diagnostic application 212 located within the control station 110. The network diagnostic application 212 includes a user interface and is operable to cause display of the statistics, as well as the parsed message information itself. The network diagnostic application 212 may generate further statistics based on the information received from the message extractor 210.

In a preferred embodiment, the message extractor 210 may also be accessed by remote applications, through, for example, the management level network 122. To this end, the message extractor 210 may be an object, such as a DCOM object, that is accessible generally through the Ethernet connection of the management level network, using techniques known in the art. Thus, an operator at another node, or even at a location that connects through the Internet via the Internet server 116, may obtain network performance data from the message extractor 210 in the control station 110.

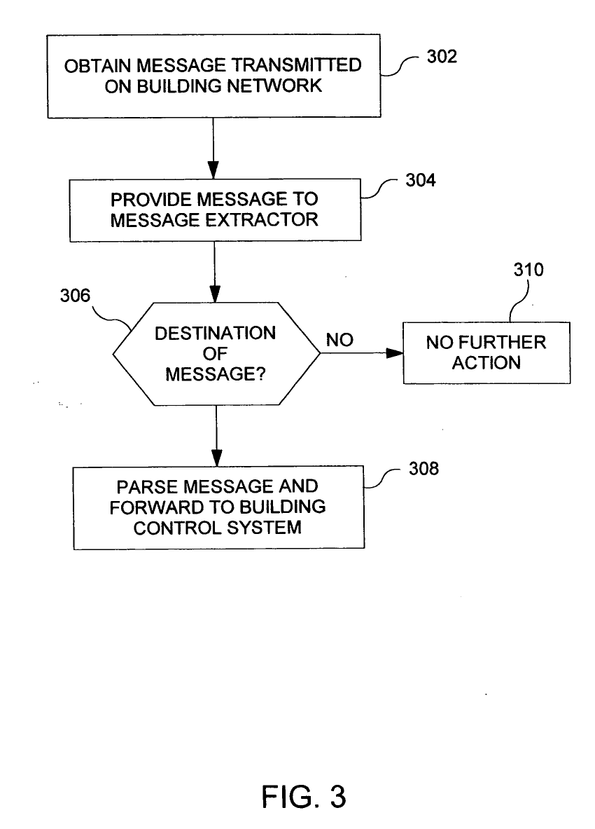

FIG. 3 shows exemplary operations of the network communications driver 208 of FIG. 2 when messages are received from the building network 124. In particular, every message on the building network 124 is processed as shown in FIG. 3 by the driver 208. Each message is received (step 302) and then passed to the message extractor 210 (step 304). The driver 208 then determines whether the control station 110 (i.e. the building data management system 204) is the destination of the message (step 306). If so, the building network protocol overhead is parsed and the message is passed to the building data management system 204 via the adapter 206 (step 308). If not, however, (step 310), the driver 208 need not do anything further with the message.

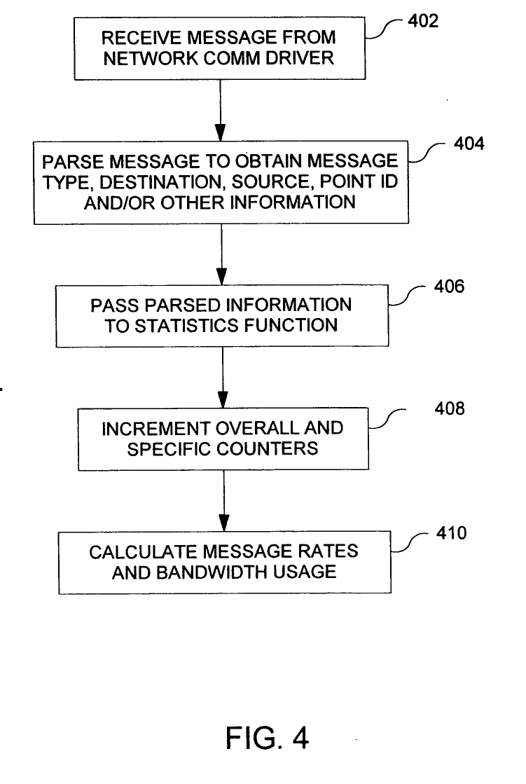

FIG. 4 shows a flow diagram of the operations performed by the elements of the message extractor 210 of FIG. 2. FIG. 5 shows a functional block diagram of the message extractor object 210, and will be referenced simultaneously.

In step 402, the parser 210a receives the message from the driver 208. In step 404, the extractor 210 parses the message to obtain source, destination, message type, and point identification from the message. The source identifies the source of the message on the building network 124 (e.g. floor level network interface 136), the destination identifies the destination of the message on the building network 124 (e.g. control station 110), and the message type identifies whether the message is measured data, a command, an alarm, a status value, or any other message type that is useful in building control system communications. The point identifier identifies either the device that generated the data or simply the system variable for which the data is the current value. For example, a point may be the thermostat 140a (device). A point may alternatively be the temperature at the thermostat 140a (system variable).

To perform the parsing step, the parser 210a extracts various fields from the message that contain the relevant information. In one embodiment, the parser 210a first extracts message type information and then performs the remaining parsing steps based on the message type. In particular, because different message types may contain different information or have different body formats, it may be advantageous to obtain the message type to determine how and/or what to parse from the remainder of the message. The parser 210a is in any event capable of determining the message type and protocol and obtain the relevant usage-related information therefrom. In the embodiment described herein, the relevant usage-related information includes source, destination, message type, and point identification information.

In step 406, the parser 210a provides the information to the statistics function 210b. FIG. 5 shows a logical functional diagram of the statistic function 210b. In general, the statistic function 210b receives the parsed message information from the parser function 210a, calculates various statistics or other derived information, and provides the derived information as outputs. The outputs may be obtained and displayed (or printed) by the local diagnostic application 212, or by applications located at different hosts.

Referring again to FIG. 4, in step 408, the statistics function 210b increments various counters for different types of messages. In particular, the statistics function 210b accumulates the total number of messages. The accumulated message count may be reset daily, weekly, hourly, or at some other interval. The statistics function 210b further maintains a separate counter for one or more specific types of messages, such as device data, alarms, retry messages, or commands. To this end, as discussed above, the statistics function 210b obtains the message-type information for each received message and increments the appropriate counter.

Accordingly, for each message received from the parsing function 210a, the statistics function 210b increments an overall message counter, and a message counter corresponding to its particular message type. It will be appreciated that other specialized counters may be maintained, such as counters for messages based on destination, source, or the like.

In step 410, the statistics function 210b may from time to time determine message rates. A message rate that identifies the current rate at which messages are being passed through the network 124. To this end, the statistics function 210b determines (using the message counter), the number of messages counted over a certain time interval and then divides the number of messages by the time interval to determine the rate. The message rate may be maintained as a running value or may be simply calculated anew after a predetermined rate calculation interval. The most recent calculated message rate values are made available as an output.

The statistics function 210b preferably maintains an overall message rate, as well as a message rate for each message type by determining the total number of each type of message detected over a discrete time period. FIG. 5 shows an exemplary set of message rates that may be provided as outputs.

In step 410, the statistics function 210b may also determine the bandwidth usage by determining the overall message rate as a function of the available bandwidth of the building network 124. In particular, if the general size of each message is known, and if the message rate is determined, then the total rate of databits being placed through the network 124 is known. The application 212 divides the total rate of databits placed through the network 124 by the bandwidth of the network 124 to determine the bandwidth usage.

It will be appreciated that step 410 need not be executed in any particular order in the flow diagram of FIG. 4. Moreover, step 410 need not be executed each time a new message is received in step 402. The message rates and bandwidth usage statistics may be calculated on a less frequent basis.

Referring again to FIG. 2, as discussed above, the diagnostic application 212 is operable to display the message counters, message rates and bandwidth usage. In one embodiment, the diagnostic application 212 displays all of such information simultaneously along with a scrolling list of the actual messages. To this end, the message extractor 210 may also maintain a log 210c of information from individual message of a finite number of the most recent messages. (See FIG. 5). The message log 210c may also be provided as an output to the diagnostic application 212 and other applications. The availability of log information provides additional insight as to the propagation of messages through the network 124.

As discussed above, the usage information generated by the message extractor 210 may be displayed locally at the control station 110, or may be communicated to another device over the management network 122. As shown in FIG. 2, the network message extractor 210 may be able to respond to requests for data from other control stations (e.g. control station 112 of FIG. 1) connected to the management level network 122. In another example, the message extractor 210 may be able to respond to requests for data from remote devices via the Internet server 116.

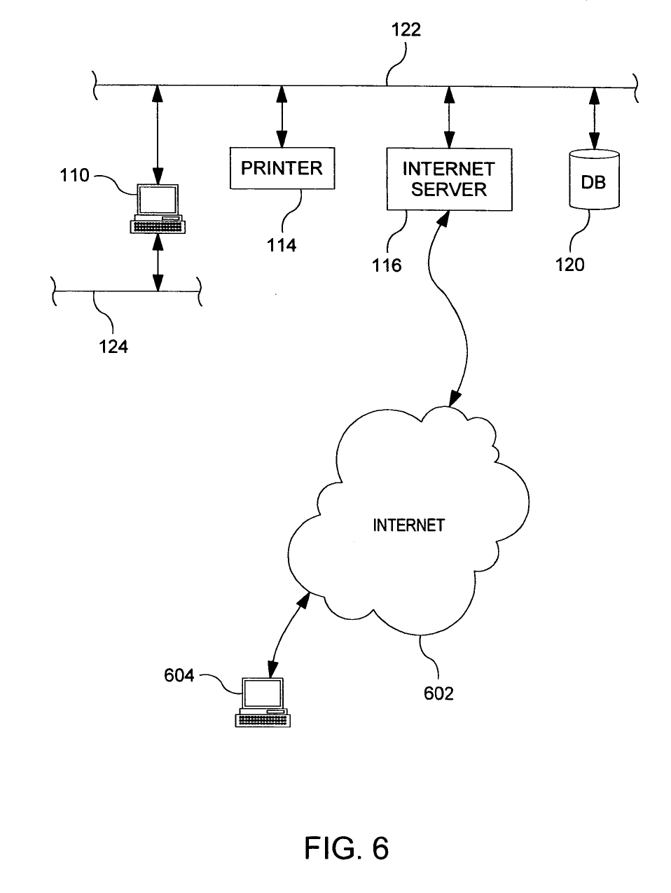

FIG. 6 shows an exemplary configuration of an arrangement for providing network usage information of the building network 124 to a remote computing device. The arrangement includes the control station 110, the management level network 122, the Internet server 116, the Internet 602, and a remotely-located computer 604.

As discussed above, the message extractor 210 of the control station 110 is an object operating on the control station 110 that is accessible by other elements on the management level network 122. The Internet server 116, in turn, operates as a server to remote clients over the Internet. The remotely-located computer 604 preferably includes web-browser software as is known in the art that allows it to render Internet standard web data (i.e. web pages). Accordingly, in a typical transaction, the user at the remotely-located computer 604 requests data in the form of a web page from the Internet server 116. The request propagates through the Internet 602 to the Internet server 116. The Internet server 116 then formulates a web page that includes network usage data received from the message extractor 210 at the control station 110. To obtain the network usage data, the Internet server 116 preferably requests the data from the message extractor 210 of the control station 110 over the management level network 122.

In any event, the Internet server 116 transmits the network usage data over the Internet 602 to the remotely-located computer 604. To this end, the Internet server 116 may formulate a web page using HTML or other mark-up languages. Methods of transferring variable data over the Internet via web pages is well known in the art.

It is noted that in the alternative, the request for data from the remotely-located computer 604 and/or the transmission of usage data from the Internet server 116 may suitably be transmitted as electronic mail messages. The precise format of the data transmitted over the Internet 602 is largely a matter of design choice, although there advantage to transmitting the data within a formulated web page.

It will be appreciated that some building control systems employ multiple building level networks that may or may not share the same hardware and/or communication protocol. For example, one building level network may be employed by the fire safety system of a building, while another building level network is employed by the HVAC system. It is not uncommon to have three or more separate building level networks in a building control system such as the system 100 of FIG. 1.

To this end, a control station such as the control station 110 may be configured to communicate with and control devices that are connected (directly or indirectly) to different building level networks. For example, the INSIGHT™ model control station available from Siemens Building Technologies, Inc., is capable of communicating over a plurality of different building level networks, such as BACnet and standard Ethernet networks, as well as RS-485 based networks that use proprietary protocols. In accordance with an embodiment of the invention, a control station such as the control station 110 may be configured to monitor the communication operations of multiple building level networks.

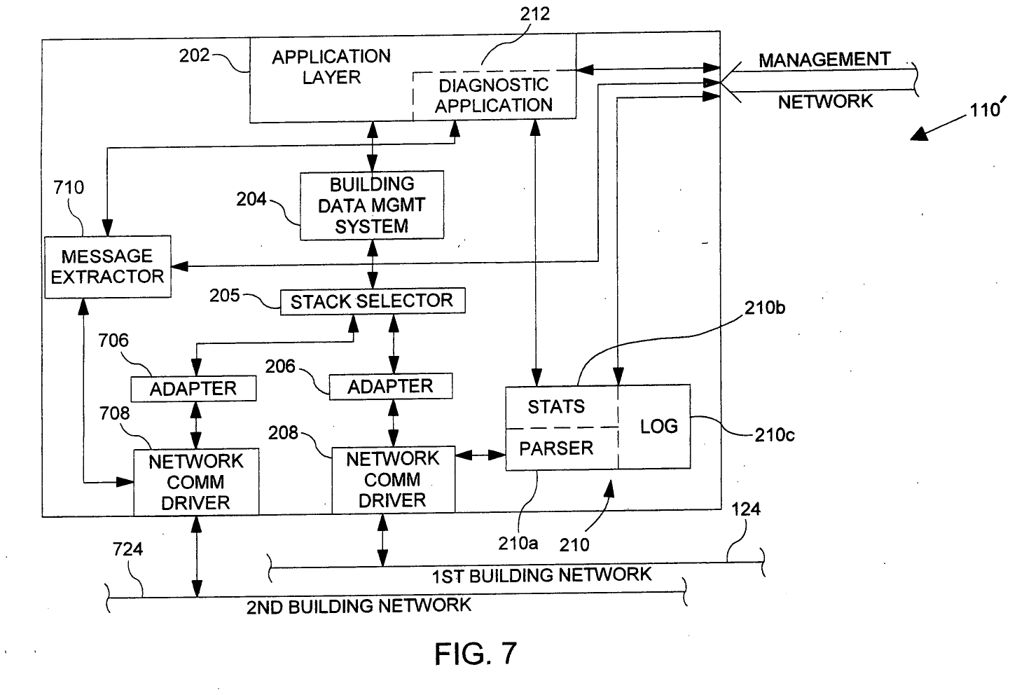

FIG. 7 shows an exemplary alternative control station 110′ that communicates on, and monitors, two different building level networks 124 and 724. The control station 110′ of FIG. 7 shares many components with the control station 110 of FIG. 2 and like reference numbers are used to describe like elements.

In this case, the two building level networks 124 and 724 are separate physical networks that connect to different sets of devices in the building control system. By way of example, a fire safety system may employ the building level network 724 while HVAC devices employ the building level network 124. It will be appreciated that the invention is not limited to use with two building level networks but may instead be used with any number of networks.

The control station 110′ may suitably be a general purpose computer which is configured to perform the functions ascribed to it herein. The functional blocks of the control station 110′ shown in FIG. 7 are carried out by a suitably configured combination of hardware and software within the control station.

Similar to the control station 110 of FIG. 2, the functional blocks of the control station 110′ include an application layer 202 and a building data management system (client/server combined in this case) 204. The control station 110′ also includes two adapters 206 and 706, two communication network drivers 208 and 708, and two message extractors 210 and 710. The control station 110′ further includes a stack selector 205 that is operable to route data between the building data management system 204 and the building level networks 124 and 724.

To this end, the stack selector 205 is coupled to each of the adapters 206 and 706. The adapter 206 is further coupled to the network communication device 208 as discussed above in connection with FIG. 2. The adapter 706 is further coupled to the network communication device 708 in a similar manner. The network communication driver 208 is operably coupled to the building level network 124 while the network communication driver 708 is operably coupled to the building level network 724.

As discussed above in connection with FIG. 2, the application layer 202 provides all user interface functions as well as special control applications. The building data management system 204 includes, among other things, the data server that controls, among other things, 1) the obtaining of data from remote system devices via the building level networks 124 and 724 pursuant to requests made by the application layer 202, 2) the communication of commands from the application layer 202 to remote system devices via the building level networks 124 and 724, and 3) the obtaining of alarm information from the remote system devices via the building level networks 124 and 724.

Apart from the ability to monitor, control and display information regarding elements on two different building level networks 124 and 724, the building data management system 204 has similar capabilities as those discussed above in connection with FIG. 2.

The stack selector 205 is operable to route information from the building data management system 204 to the appropriate building level network. Thus, if the building data management system 204 sends a command to the terminal equipment controller 140b of FIG. 1, which is connected (indirectly) through the building level network 124, then the stack selector 205 directs the command to the building level network 124 through the appropriate adapter 206 and network communications driver 208. If, however, the building data management system 204 sends a command to a device connected to the building level network 724, then the stack selector directs the command to the network 724 through the adapter 706.

The adapter 206 is the device driver system described above in connection with FIG. 2. The adapter 706 is an analogous device driver system that converts or maps data between the format employed by the application layer 202/building data management system 204 and the format employed by the various building control devices that are connected directly or indirectly to the building level network 724. As discussed above, various building system devices employ various formats of data and/or units of data. The adapters 206 and 706 operate to convert between the various formats and a common data format used by the building data management system 204.

The network communication driver 208 is the device that adds the protocol layers necessary for communication over the building network 124, while the network communication driver 708 is the device that adds the protocol layers necessary for communication over the building network 724.

Examples of all of the above described devices would be known in the art and may be found, for example, in the Insight™ Work Station available from Siemens Building Technologies, Inc.

The message extractor 710 operates in the same manner as the message extractor 210 described further above. However, the message extractor 710 is specifically configured to parse and collect data regarding a network having communication protocols and/or message structures that are different than those for which the message extractor 210 is configured. In particular, the message extractor 710 is specifically configured to parse and collect message data from the building level network 724.

Thus, while the message extractor 210 is preferably operable to obtain substantially every message from the building level network 124 via the network communication driver 208, regardless of whether the message is addressed to the building data management system 204, the message extractor 710 is preferably operable to obtain substantially every message from the building level network 724 via the network communication driver 708.

It is noted that the network communication driver 708 will also forward messages intended for (i.e. addressed to) the building data management system 204 to the adapter 706, which in turn will provide converted message information to the building data management system 204 through the stack selector 205. All messages addressed to other nodes are not passed on to the building data management system 204 by the network communication driver 708, even though they are received and processed by the message extractor 710.

Similar to the message extractor 210, the message extractor 710 is preferably a software object running on the control station 110 that obtains traffic-related data from each message. To this end, the message extractor 710 may suitably have the same functional structure as the message extractor 210 shown in FIG. 5.

The message extractors 210 and 710 may be accessed by the network diagnostic application 212 located within the control station 110′. In a preferred embodiment, the message extractors 210 and 710 may also be accessed by remote applications, through, for example, the management level network 122 (see FIG. 1). To this end, each of the message extractors 210 and 710 may be an object, such as a DCOM object, that is accessible generally through the Ethernet connection of the management level network, using techniques known in the art. Thus, an operator at another node, or even at a location that connects through the Internet via the Internet server 116, may obtain network performance data from the message extractors 210 and 710 in the control station 110′.

Thus, the above embodiment illustrates that multiple building level network monitoring objects may be implemented on a single building control system control station. It is noted that multiple message extractors may also be implemented on the same physical network if multiple communication protocols are employed on the same physical network.

It will be appreciated that the above described embodiments are merely exemplary and that those of ordinary skill in the art may readily devise their own implementations that incorporate the principles of the present invention and fall within the spirit and scope thereof. For example, the invention is not limited to the exact types of network usage data discussed above, or combination of network usage data described above.

I claim:

1. An arrangement for use in a building system comprising:
a building control station operably connected to a first network, the building control station having a first network address on the first network, the building control station further comprising,
a network interface operable to receive first and second messages on the first network,
a building control object operably coupled to receive first messages from the network interface, the building control object operable to process building control data based on at least some of the received first messages, and
a network monitor object operably coupled to receive first messages and second messages from the network interface, the network monitor object operable to determine at least a first statistic regarding the first network based on the first messages and second messages.

2. The arrangement of claim 1 wherein the first messages include a destination address that corresponds to the first network address, and the second messages include a destination address that corresponds to one or more of a plurality of different network addresses.

3. The arrangement of claim 1 wherein the building control object is operable to receive a request for building control information from an external input,
cause the network interface to send a request message over the first network, the request message configured to obtain the requested building control information.

4. The arrangement of claim 1 wherein the building control data includes data relating to the operation of heating, ventilation and air-conditioning equipment.

5. The arrangement of claim 1 wherein the network monitor object is configured to determine at least a first usage statistic regard the first network,

6. The arrangement of claim 1 wherein the usage statistic includes a message count, the message count representative of a count of first and second messages.

7. The arrangement of claim 1 wherein the building control station is further operable to communicate on a second network to a plurality of other computing devices.

8. The arrangement of claim 7 wherein the building control station is further operable to communicate information representative of the at least one statistic regarding the first network to one of the plurality of other computing devices using the second network.

9. The arrangement of claim 8 wherein the one of the plurality of other computing devices includes an Internet server, the Internet server operable to provide the information representative of the at least one statistic to a remote computer using the Internet.

10. A method comprising:
receiving at a first computing device a first message from a first network, the first message including a first destination address and building control data pertaining to the operation of one of a plurality of building control devices;
updating a first network usage statistic maintained in the first computing device responsive to receiving a first message; and
processing the building control data in the first computing device responsive to receiving the first message if the first destination address corresponds to the first computing device.

11. The method of claim 11, further comprising
receiving a request for the building control data from an external input,
causing the network interface to send a request message over the first network, the request message configured to obtain the requested building control data.

12. The method of claim 11 wherein the building control data includes data relating to the operation of heating, ventilation and air-conditioning equipment.

13. The method of claim 11 wherein the usage statistic includes a message count, the message count representative of a count of messages communicated on the first network.

14. The method of claim 11 further comprising communicating information representative of the usage statistic to one of the plurality of other computing devices using the second network.

15. The method of claim 11 further comprising communicating information representative of the usage statistic to one of the plurality of other computing devices using the Internet.

15. The method of claim 11 further comprising
communicating information representative of the usage statistic to an Internet server using a second network; and
employing the Internet server to provide the information representative of the usage statistic to a remote computer using the Internet.

16. The method of claim 11 further comprising updating a plurality of network usage statistics maintained in the first computing device responsive to receiving a first message.

17. A method comprising:
receiving at a first computing device a first message from a first network, the first message including a first destination address and building control data pertaining to the operation of one of a plurality of building control devices, at least some of the building control devices operably connected to the first network;
updating a first network usage statistic maintained in the first computing device responsive to receiving the first message; and
communicating information representative of the first network usage statistic to one of the plurality of other computing devices using the Internet.

18. The method of claim 17 wherein the communicating step further comprises:.
communicating information representative of the first network usage statistic to an Internet server using a second network; and
employing the Internet server to provide the information representative of the usage statistic to a remote computer using the Internet.

19. The method of claim 17 wherein the first network is a token bus network.

20. The method of claim 17 further comprising
updating a plurality of network usage statistics maintained in the first computing device responsive to receiving the first message; and
communicating information representative of a select set of network usage statistics from the plurality of network usage statistics to one of the plurality of other computing devices using the Internet.
